(19) United States
(12) Patent Application Publication
(10) Pub. No.: US 2023/0306967 A1
(43) Pub. Date: Sep. 28, 2023

(54) PERSONAL ASSISTANT MULTI-SKILL

(71) Applicant: NOS INOVACAO, S.A., Senhora da Hora (PT)

(72) Inventors: Carlos Filipe LOPES TORRAO, Senhora da Hora (PT); Carolina Pimentel FERNANDES MAIO, Senhora da Hora (PT); Bruno SOUSA ROSA CRUZ FERNANDES, Senhora da Hora (PT); Joao Miguel NUNES FERREIRA, Senhora da Hora (PT); Jorge Filipe PINTO SEQUEIRA DOS SANTOS GRACA, Senhora da Hora (PT)

(21) Appl. No.: 18/002,615

(22) PCT Filed: May 30, 2022
(86) PCT No.: PCT/IB2022/055060

§ 371 Date: Dec. 20, 2022

(30) Foreign Application Priority Data
May 31, 2021 (PT) 117263

(51) Int. Cl. G10L 15/22; G06N 3/006; G06F 40/35; G10L 15/18

(52) U.S. Cl. CPC G10L 15/22; G06F 40/35; G06N 3/006; G10L 15/1815; G10L 2015/223; G10L 2015/228

(57) ABSTRACT

A computer implemented platform with the responsibility of handling complex tasks provided by users via a natural input interface (voice, text, image, among others). This platform design is based on the principle of full scalability, ambient and context awareness and with multi-domain extensible capability. The proposed computer-implemented system ensures the handling of input data provided by users via natural input interfaces, comprising a set of layers arranged in a modular and loosely coupled architecture, wherein the set of layers are adapted to interpret and manage several types of contextual information from the user input data, while permanently improving decisioning and response times, enabling increasingly complex interactions with the user.

### TECHNICAL FIELD

The present invention describes a computer implemented platform configured to handle complex tasks provided by users via a natural input interfaces.

### BACKGROUND ART

Some known state of the art approaches with regard to virtual assistants disclose systems and methods for processing a user utterance with respect to multiple subject matters or domains, and for selecting likely results from a particular domain with which to respond to the utterance or otherwise take action. A user utterance may be transcribed by an automatic speech recognition (“ASR”) module, and the results may be provided to a multi-domain Natural Language Understanding (“NLU”) engine. The multi-domain NLU engine may process the transcription(s) in multiple individual domains rather than in a single domain. In some cases, the transcription(s) may be processed in multiple individual domains in parallel or simultaneously. In addition, hints may be generated based on previous user interactions and other data. The ASR module, multi-domain NLU engine, and other components of a spoken language processing system may use the hints to more efficiently process input or more accurately generate output.

However, this approach does not consider the context of previous conversations, ambient context of which events are occurring, or even the interaction channel that originated the conversation. Present disclosed invention aims to overcome present know state-of-the-art approaches, introducing new methodologies to further include additional features to these existing approaches.

### SUMMARY

The present invention describes a computer-implemented system for handling input data provided by users via natural input interfaces, comprising a set of layers arranged in a modular and loosely coupled architecture, wherein the set of layers are adapted to interpret and manage several types of contextual information from the user input data, while permanently improving decisioning and response times, enabling increasingly complex interactions with the user.

In a proposed embodiment of present invention, the set of layers comprises at least one of a Device Layer, Conversational Context Layer, Ambient Awareness Context Layer, Core Conversational Management Layer, Multi-Skill Layer, Cognitive Enhancement Layer, Knowledge Layer, Event dispatch layer, Data Seeding Layer, and Health Monitoring and Reporting Layer.

Yet in another proposed embodiment of present invention, the several types of contextual information comprises at least one of a Persistent User Specific Contextual Information composed by user preferences such as settings and configurations added to improve decisioning; Persistent Secure Information composed by keywords, passwords or authorization tokens securely stored to minimize security measures for internally access said info; and Conversational Transient Information composed by multiple independent hosts configured to maintain a set input data iteration alive with the user.

Yet in another proposed embodiment of present invention, the Core Conversational Management Layer is composed by a conversational AI agent core comprising a dispatcher and multi-skill NLU models, the conversational AI agent core being configured to perform and understand multi-step conversational context of the user input data through the device layer in order to determine which output data should handle said user input data, and identify a conversation failure fallback from a user input data through a dedicated mechanism configured to allow a transient context to be considered, allowing to start a new command request.

Yet in another proposed embodiment of present invention, the multi-skill NLU models comprises multiple NLU models.

Yet in another proposed embodiment of present invention, the multi-skill layer is composed by skills which comprise specific NLU skills and specific skill actuators, the multi-skill layer being configured to enable, disable and include additional skills to ensure adaptability.

Yet in another proposed embodiment of present invention, the Cognitive Enhancement Layer is configured to enrich the user input data with cognitive AI processing through the reuse of the input data thus creating enriched standards for all used skills.

Yet in another proposed embodiment of present invention, the knowledge layer is configured to maintain all the input data, output data and knowledge created by the set of layers structured, relational, and/or unstructured.

Yet in another proposed embodiment of present invention, the ambient awareness context layer is configured to update a materialized view of the surrounding world, through an Ambient Context Awareness Manager, comprising at least two variables: surrounding environment, and interaction channel location wherein the combination of the at least two variables allow to improve the dispatcher decision and response time by providing to the skills additional data and metadata that value and enrich the data input in order to obtain more accurate and engaging interactions with the user.

Yet in another proposed embodiment of present invention, the natural input interfaces are comprised in a Device layer are composed by 3rd party voice/text/image interactive systems and/or 1st party voice/text/image interactive systems connected to a Single Cross Platform Endpoint through channels, said device layer being configured to both capture video, images, audio or text input and/or output visuals such as video, images, audio or text.

Yet in another proposed embodiment of present invention, the event dispatch layer comprises an AI Agent Scheduled Tasks and AI Live Events configured to deliver external events to the dispatcher triggered by an external Global Events Hub Manager through an Event Context and Data.

Yet in another proposed embodiment of present invention, the data seeding layer comprises a set of independent AI data seeders configured to track-back, gather, perform the necessary modifications, and deliver the input data, output data and knowledge created by the set of layers to the Knowledge Layer.

Yet in another proposed embodiment of present invention, the Health Monitoring and Reporting Layer is configured to collet, process and store audit and log events from the remaining layers to produce multiple performance, business and Health monitoring reports which comprise predictive analytics and anomaly detection.

Yet in another proposed embodiment of present invention, the conversational context layer comprises a conversational context manager configured to maintain multi-step conversations with the users, ensuring maintenance of conversational statements and preferences particular to said conversations through storing and collecting conversational context for each user input data.

Yet in another proposed embodiment of present invention, the dispatcher is configured to retrieve Output data in response to a user input data through the natural input interfaces while providing related details with the Conversational Context Manager for storage, determining what skill or Multi Skill NLU Models is suitable to be addressed to the current conversational context alongside with the remaining metadata.

The present invention further describes a data processing system, comprising the physical means necessary for the execution of the computer-implemented system described in any one of the previous claims.

The present application further describes a computer program, comprising programming code or instructions suitable for carrying out the computer-implemented system described in any of the previous claims, in which said computer program is stored, and is executed in a said data processing system, remote or in-site, for example a server, performing the actions described in the claims.

The present application further describes a computer readable physical data storage device, in which the programming code or instructions of the computer program described are stored.

### GENERAL DESCRIPTION

The present application describes a computer implemented platform that follows the principle of a modular architecture, comprising a set of layers, each one responsible for one part of the overall solution of handling complex inputs. The inputs may comprise voice, text, image, among others in a non-limiting manner.

The overall conceptual architecture describes a Personal Assistant Multi-Skill (PAMS) that, from a macro perspective, comprises a set of block layers. Each of the block layers defined in the architecture represents an operational aspect of PAMS platform. On the designed architecture, it is possible to anticipate the existence of a Device Layer, a Conversational Context Layer, an Ambient Awareness Context Layer, a Core Conversational Management Layer, a Multi-Skill Layer, a Cognitive Enhancement Layer, a Knowledge Layer, an Event dispatch layer, a Data Seeding Layer and a Health Monitoring and Reporting Layer.

The PAMS platform was developed to perform a step ahead from the presently known simple Natural Language Understanding based routers, since it takes into account context from previous conversations, ambient context of events that are presently happening, or the place and channel the interaction originated from, and user specific context from preferences and other aspects, to decide the best Skill to activate and empower that skill with all that data. This set of singular features positions the PAMS platform apart from any other existing Virtual Assistant frameworks. Although being based on similar principals of NLU dispatching, trying to solve the same problem of building a general domain, the truly extensible Virtual Assistant PAMS platform has a unique ability to achieve this feature.

The PAMS platform ambient awareness is focused on two main points. The first one is the general representation of the surrounding world in terms of ambient variables (state of the overall system and network, global incidents that may affect customer services, what is on TV at this moment, what is the temperature outside, etc.).

The second one is the location and channel used for that interaction, for example if the interaction was done via a Cellphone App, or via a Dedicated Hardware, or a state-of-the-art existing 3^{rd} party virtual agent, and where is the device located in the world and inside the telecom operator’s network (is the device connected to the user’s home network, where is the location of that interaction, etc.).

Merging these two pieces of information with each other will add a very specific set of ambient awareness that the proposed PAMS architecture can then use to determine first layer interactions that may be important for the skill dispatch decision, as well as adding all of that information to the skills input, adding all that value and richness to the user’s verbal/text/image input and enabling more intelligent and engaging interactions to be built.

Context is a key factor of differentiation in PAMS platform. PAMS ability to save and manage several types of contextual information as a built-in feature is a great accelerating and enabler for more complex interactions to be built.

One of the contextual information used by the PAMS platform is the Persistent User Specific Contextual Information, which comprises information related to the user’s preferences such as settings and configurations set from past interactions, and other personal information specific to that user and that can be added to the skills request (if already set) and allow the skill to skip questions to the user as it is already a known fact.

Another aspect on this contextual information is the Persistent Secure Information, such as keys and passwords or authorization tokens the user has set in the past, giving PAMS access to a given service, and that are stored in a secure store and have a safe and secure method of access by each skill. This way skills do not need to implement security measures for accessing and storing sensible data as this is built-in to the platform itself.

An additional contextual information is focused on the Conversational Transient Information, this allows PAMS to keep a conversation alive without having to create affinity to a given machine/host of the physical deployment of the solution to a conversation. Users can have an interaction now and get answered by one machine, and the next interaction can be solved by another machine on a different server and make sure the context from the previous interaction is passed between both machines. This single fact allows PAMS so scale to any number of machines and answer any amount of load possible. PAMS also preserves this context for a given amount of time. Skills can decide how long should a given conversation be kept alive. This allows for a simple solution for conversations that may be left incomplete by the user abandoning the conversation mid-dialog.

Finally, these encompassing characteristics creates another very differentiating and innovative solution in the Core Conversational Management layer, namely the conversation failure fallback mechanism. This fallback mechanism allows for a transient context to be taken into account with little risk to the overall experience given that if the user has changed his mind, and doesn’t mean to finish the previous conversation flow, starting a new command for another skill, PAMS will understand that by the failure in the resolution of the previous dialog skill while a new best fit skill is now a match from the NLU dispatcher.

Another unique feature in PAMS platform is the fact that cognitive enrichment of inputs is done centrally and not particularly related to specific skills. This is achieved through reusing this input data as much as possible and creating a standard for all skills that are used to have access to the enriched version of the input, and not just the raw input itself. For example, if a user sends an image attached to the input, then PAMS automatically will transmit that image through all relevant cognitive Artificial Intelligence (AI) Services to collect as much information it can about the image (facial recognition, object recognition, etc.) and then send the raw information, as well as all results from this enrichment down to the Skill.

Ambient awareness contextual information is also vast and can be scattered on different systems, and thus would require a complex integration to be implemented. Another point to take into account is that systems such as these could not be built with time response as a requirement, and thus, could slow the platform to respond, impacting in the overall experience if accessed directly and synchronously. Also, the fact that these interactions could be opened to the public, could generate a very large amount of load to the services that could cause a catastrophic failure in the system. This taken into account, PAMS was developed to comprise a unique approach to ambient contextual information through data Seeder jobs which are responsible for updating a materialized view of the world, independently from other systems. This PAMS Ambient Awareness Data Model represents a snapshot as updated as possible of the world. This creates a resilient solution to external system’s momentarily being offline, creating a protection for high load from PAMS to these systems, while at the same time creating a solution for fast response time when necessary in this solution.

Another unique aspect of the PAMS platform resides in the approach of a modular and loosely coupled platform, i.e., allowing the extensibility through a truly loosely coupled architecture. This means that each piece is independent and can evolve, be replaced or rearchitected at any time. There is no lock-in to any given technology or provider, making this solution highly adaptable and durable. Other approaches normally are more centered around a set of solutions and technologies usually the NLP part of the Architecture. In PAMS allows to evolve and replace each part of the platform, keeping it always up to date.

### BRIEF DESCRIPTION OF THE DRAWINGS

For better understanding of the present application, figures representing preferred embodiments are herein attached which, however, are not intended to limit the technique disclosed herein.

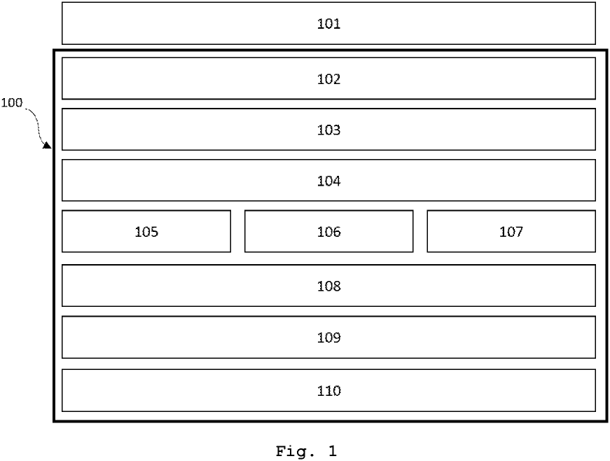

FIG. 1 represents the module overall system architecture of the PAMS platform (100), where:
100 - system / PAMS platform;
101 - device layer;
102 - conversational context layer;
103 - ambient awareness context layer;
104 - core conversational management layer;
105 - multi-skill layer;
106 - cognitive enhancement layer;
107 - knowledge layer;
108 - event dispatch layer;
109 - data seeding layer;
110 - health monitoring and reporting layer.

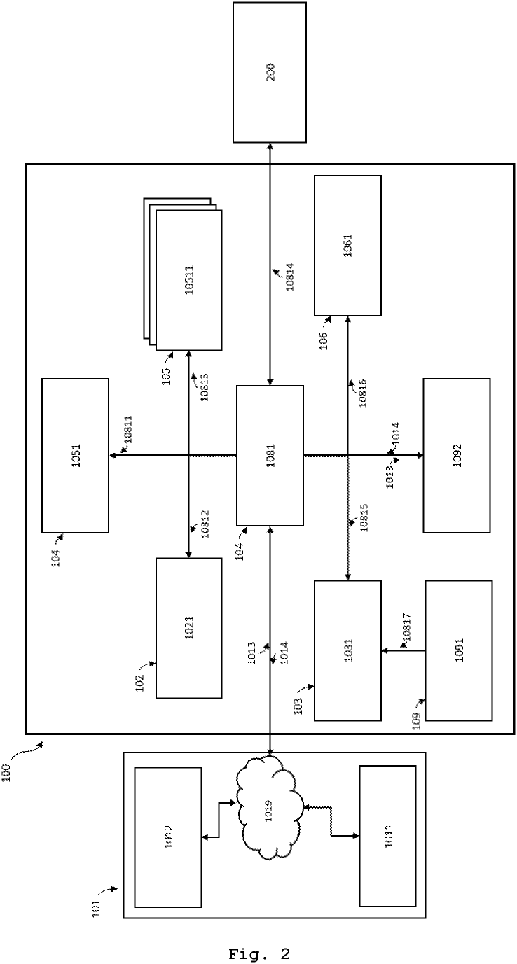

FIG. 2 represents the overall High-Level logical system architecture of the PAMS platform (100), where:
100 - system / PAMS platform;
101 - device layer;
102 - conversational context layer;
103 - ambient awareness context layer;
104 - core conversational management layer;
105 - multi-skill layer;
106 - cognitive enhancement layer; party);
109 - data seeding layer;
200 - global events hub manager;
1011 - 3^{rd} party voice/text/image interactive system device;
1012 - 1^{st} party voice/text/image interactive system device;
1013 - Text/Audio/Image Input;
1014 - Text/Audio/Image Output;
1019 - Single Cross Platform Endpoint
1021 - conversational context manager;
1031 - ambient awareness context manager;
1051 - multi-skill NLU models;
1061 - specific skill model and service (1^{st} and 3^{rd} party)
1081 - dispatcher;
1091 - AI data seeders;
1092 - Automatic Speech Recognition (ASR) / Text to Speech (TTS) models ;
10511 - skills;
10811 - Text input to find Best matching skill;
10812 - Structured Context Entities;
10813 - Full Context and User Input;
10814 - Event Context and Data;
10815 - Structured Context Entities;
10816 - Text/Image Inputs for Cognitive Processing.

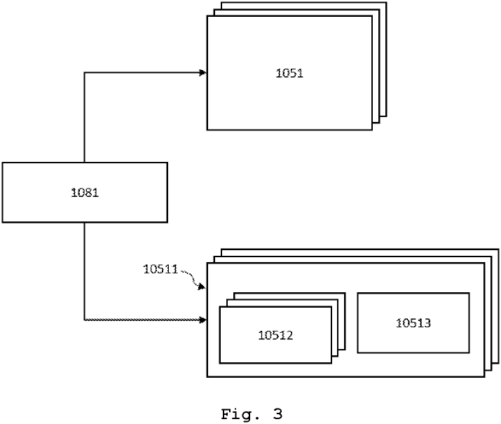

FIG. 3 represents the High-Level Logical Architecture of the dispatcher (1081), where:
1051 - multi-skill NLU models;
10511 - skills;
10512 - specific NLU skills;
10513 - specific skill actuators.

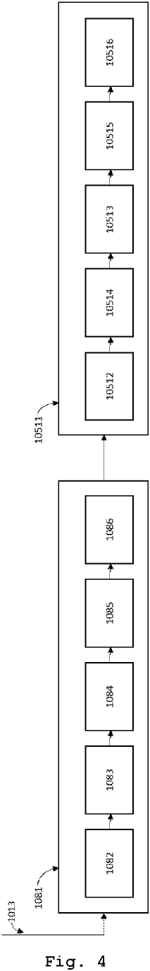

FIG. 4 - represents an overview of the User Input Flow through the use of text/voice/image, where:
1013 - text/audio/image input;
1081 - dispatcher;
1082 - voice input to text processing;
1083 - conversational context retrieval;
1084 - ambient context retrieval;
1085 - cognitive input processing;
1086 - skill detection ranking;
10511 - skills;
10512 - specific NLU skills;
10513 - specific skill actuators, activations and actions;
10514 - intent & entity processing;
10515 - response generation;
10516 - conversation context update.

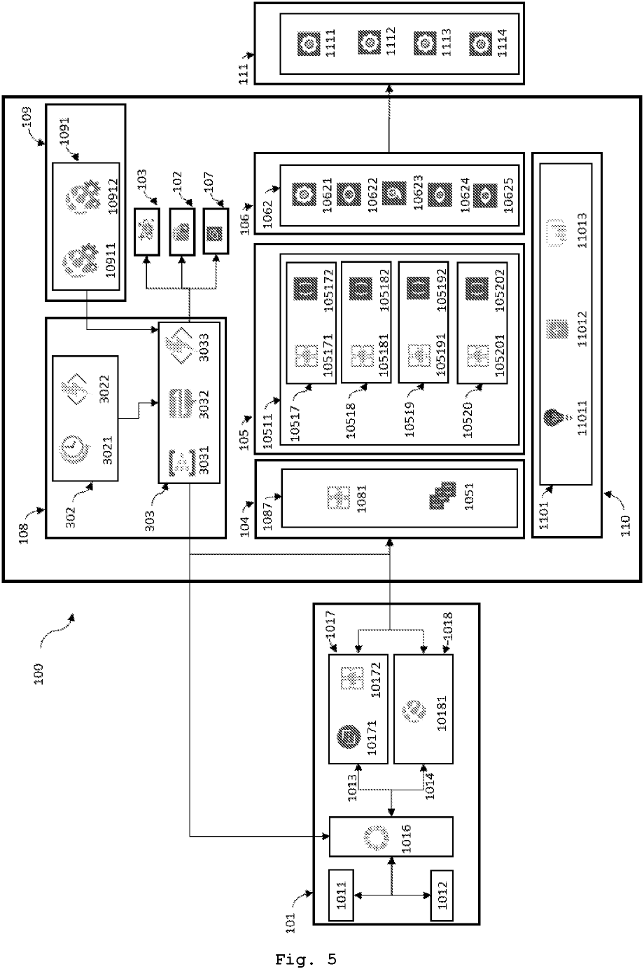

FIG. 5 - represents the Overall Logical Architecture of the PAMS platform (100), where:
100 - system / PAMS platform;
101 - device layer;
102 - conversational context layer;
103 - ambient awareness context layer;
104 - core conversational management layer;
105 - multi-skill layer;
106 - cognitive enhancement layer;
107 - knowledge layer;
108 - event dispatch layer;
109 - data seeding layer;
110 - health monitoring and reporting layer;
111 - service skill dependent APIs;
300 - contextual and automation modules;
302 - AI agent scheduled tasks;
303 - AI agent live events;
1013 - Text/Audio/Image inputs;
1014 - Text/Audio/Image outputs;
1016 - channels;
1017 - cloud endpoint;
1018 - OnPrem endpoint;
1051 - multi-skill NLU models;
1062 - common bot intelligence services;
1081 - dispatcher;
1087 - conversational AI agent core;
1091 - AI data seeders;
1101 - cross cutting core services;
1111 - TV Service Skill Dependent APIs;
1112 - Internet Service Skill Dependent APIs;
1113 - Home Service Skill Dependent APIs;
1114 - 3^{rd} Party Service Skill Dependent APIs;
3011 - current context cache DB;
3012 - secure key vault;
3013 - catalogue data DB;
3014 - questions and answers knowledge base;
3015 - user persistent context storage;
3021 - scheduler;
3022 - event dispatcher;
3031 - event hub;
3032 - notification service;
3033 - event logic (Serverless);
10171 - bot service;
10172 - app service / bot logic;
10181 - app service / bot logic;
10511 - skills;
10517 - tv service skill;
10518 - internet service skill;
10519 - home automation service skill
10520 - 3^{rd} party service skill;
10621 - entity linking service;
10622 - face recognition;
10623 - text analytics;
10624 - computer vision service;
10625 - emotion recognition service;
10911 - user profile and actions seeder;
10912 - catalogue data seeder;
11011 - application monitoring;
11012 - application logs;
11013 - reporting dashboards;
105171 - tv service skill;
105172 - tv skill specific model;
105181 - internet app service;
105182 - internet skill specific model;
105191 - home automation app service;
105192 - home automation skill specific model;
105201 - app service;
105202 - service skill specific model.

### DESCRIPTION OF EMBODIMENTS

With reference to the figures, some embodiments are now described in more detail, which are however not intended to limit the scope of the present application.

A particular embodiment of the PAMS platform disclosed herein, and going deeper on the solution description and architecture, and as shown in FIG. 2, from a logic perspective the are three main components, the Device layer (101), the PAMS platform (100) as a hole, and the Global Events Hub Manager (200).

With regard to the Device Layer (101), this module represents the physical devices that users will see and use to interact with the PAMS platform (100). This layer resorts to the use of 1^{st} and/or 3^{rd} Party (Voice / Text / Interactive Image Systems) devices (1011, 1012) which can comprise one of an off-the-shelve Voice Interaction Device, as well as mobile devices such as cell phones that comprise all the required voice interaction enabling hardware and/or software (such as microphone and speakers). These 1^{st} and/or 3^{rd} Party physical devices (1011, 1012) will enable and allow the users to capture voice, text, or images and output visuals (such as video or images), audio or text. Different devices may have different combinations of input and output capabilities and can comprise 1^{st} party or 3^{rd} party sources. Within these combinations, the 1^{st} and/or 3^{rd} party devices (1011, 1012) can be encompassed in at least one of a VoIP video conferencing app/hardware, text message app, virtual assistants, remote control, set top box, TV app, Voice app, etc. There is also the possibility to use dedicated devices developed specifically for the PAMS platform (100). This generic integration capability is a differentiating technical feature on this architecture, and it is materialized into a Cross-platform endpoint (1019). This will create and ensure an abstraction level that will allow to achieve a unique platform that can be integrable with any present or future Interaction System Device, making this solution fully scalable and generic. The PAMS platform (100) is responsible for ensuring the support to all and any device type and/or hardware provider that can fulfill the global requirements of interaction through the use of Natural Language (text or Voice) inputs and images (Photos or Video), providing a possible combination of outputs in the format of Text, Audio and/or Image playback. This includes the possibility of seamless integration of existing and future Off-the-shelf home assistant hardware. The channels (1016) are to be interpreted as the communication path which allows collecting the required data from the user through the 1^{st} and/or 3^{rd} Party (Voice / Text / Interactive Image Systems) devices (1011, 1012), and the core platform is responsible to implement an abstraction level that allows the seamless integration with all known and future main stream voice virtual assistant channels (1016), as well as some of known and future main text, VoIP and video based chat platforms, and finally the text/audio/image input channels (1013) for service providers hardware such as remote controls, Set top boxes, Apps or others. Once different input channels (1016) provide different types of text/audio/image input (1013) responses, i.e., user input data, the PAMS platform (100) will need to handle these differences and interpret each one of them separately and correctly. Thus, the text/audio/image input (1013) formats supported by the PAMS platform (100), independently of the channel (1016) origin, will comprise the reception of text inputs, audio inputs, image inputs and unstructured data streams, for systems such as Biometric systems, IoT sensors, etc. Once different channel Text/Audio/Image Outputs (1014), i.e., user output data, will have different requirements in terms of text/audio/image input (1013) protocol analysis, the PAMS platform (100) will need to have a layer of abstraction that allows to scale any type of input requirements that may arise in the future. To achieve this feature, and, at the same time, leverage as much as possible already developed integration, different developed endpoints will serve as ingest points for different channels (1016). Said ingest points, referred to as Single Cross Platform Endpoint (1019), depending on the channel’s (1016) specific needs, will need to be configured to integrate with the correct endpoint (1017, 1018).

This Single Cross Platform Endpoint (1019) can particularly be described as comprising a Cloud Endpoint (1017) and a OnPrem Endpoint (1018). The Cloud Endpoint (1017) is developed on top of a state-of-the-art Bot Service (10171) that leverages the PAMS platform (100) to implement the Text/Audio/Image Output (1014) integration with the chat, text and voice channels (1016) and is an active and live product that can evolve, and, with it, augment the number of channels (1016) that are supported, as well as keeping up with channel (1016) changes and integration needs also out-of-the-box. This Cloud Endpoint (1017) uses Direct Line API 3.0 as the core protocol for its integration, which serves as an abstraction protocol for all of the channels (1016). In the case of public channels, the use of the Bot Framework public infrastructure is ensured to communicate using their own specific protocols that gets translated to Direct Line and then enters the Cloud Endpoint (1017). The OnPrem Endpoint (1018), it was designed to be deployed in a local infrastructure (On Premises), allowing the integration of non-internet communications over closed networks with the channels (1016). It also allows for a REST API integration that doesn’t have the need to use the Direct Line API. This OnPrem Endpoint (1018) will allow the integration with internal systems of the service provider infrastructure, for example Set Top Boxes, as well as other owned edge devices such as Remote Controls, or TV Apps, or the Personal Assistant Edge Devices. Both of endpoints (1017, 1018) will serve as a middleware integration that has a logical component called Bot Logic that will serve both as an implementation of endpoint specific behaviours, as well as integrate with the core part of the PAMS platform (100) via the Dispatcher (1081).

The Global Events Hub Manager (200) is a simple component located outside of the PAMS platform (100) and ensures the deliverance of all the integrations with external events that get triggered by any event source service. Notifications can be related with weather alerts, IoT home appliances status change or even content that is new to a catalogue list that is predetermined in the PAMS platform (100). Similarly, to the device layer (101), this Global Events Hub Manager (200) will serve as a integration element for all and any event source that is triggered now and in the future, making the solution scalable for any future sources without severe changes in the PAMS platform (100).

The PAMS platform (100) is the core part of the solution that has a vast number of logical pieces with a modular architecture where each component is loosely coupled in a logical away, responsible for a specific part of the solution. Supported also by the analysis of FIG. 1, the overall architecture of the PAMS platform (100) comprises a conversational context layer (102), an ambient awareness context layer (103), a core conversational management layer (104), a multi-skill layer (105), a cognitive enhancement layer (106), knowledge layer (107), an event dispatch layer (108), a data seeding layer (109) and a health monitoring and reporting layer (110). Thereafter, a brief and overall approach on the importance and functionality of each of these layers.

The conversational context layer (102) is responsible for the definition of the core conversational capabilities of the PAMS platform (100) on maintaining multi-step conversations, asking follow-up questions to the users, ensuring the maintenance of conversational statements and preferences that are specific to the conversation itself. This conversational context layer (102) is a core piece in the overall functional definition of PAMS platform (100), providing a differentiating feel of intelligence and natural communication and interaction with the user of the PAMS platform (100). The conversational context is also a transient and persistent state. This conversational context layer (102) must enable both state scenarios in order to allow its implementation and execution in a conversational context manager (1021). It will keep transient contextual information during a multi-step conversation and transient information that has an expiration, for example an open request that is left answered for a long period of time, when the user returns with a new command, it does not have that open question left unanswered to cause a bad experience. It is also ensured the ability to persist information gathered in the conversation such as preferences, or configurations that are specific to interactions with the PAMS platform (100). From a conceptual perspective, the Contextual Information can have two scopes, a scope for the user, independent of the conversation, and/or a scope for the conversation. The scope is independent of the persistency of the information being set as transient or persistent, giving the PAMS platform (100) the freedom to store and manage all types of contextual information. Finally, and given the personal nature of this type of information, this layer needs to have security requirements at is core, making sure that user persistent and transient information is securely stored, following all data protection policies, guidelines and best practices.

The Conversational Context Manager (1021), which is a core part of the PAMS platform (100) Intelligence being located in the conversational context layer (102), is a key part of User Experience improvement. The Conversational Context Manager (1021) is responsible for maintaining, for each active conversation, all the contextual information of what was detected by a skill (10511) and what it returns as a Text/Audio/Image Output (1014) response. This allows the Dispatcher (1081) to be stateless and depend on this conversational context manager (1021) to store and collect conversational context for each text/audio/image input (1013). This approach makes the Conversation Context centralized, making the PAMS platform (100) able to handle long running stateful like interactions without the performance, scalability and architectural penalties and complexities of building a stateful system. This sole fact is a key part of the solution and innovation around the dispatcher (1081) creation and architecture. For each interaction that is resolved by the selected skill (10511), the PAMS platform (100) returns the conversational context entities it wishes to store, as well as the response itself. This way, the dispatcher (1081) can send the Text/Audio/Image Output (1014) response to the user’s device (1011, 1012) while sending the full details to the Conversational Context Manager (1021) for storage. As a new text/audio/image input (1013) from that user comes, the Dispatcher (1081) will ask the Conversational Context Manager (1021) to retrieve the current context and send that to the skill (10511) alongside with the remaining metadata. Another important innovation point is the fact that Skills (10511) can return a conversation state, and if that state is for example “waiting for replay”, the dispatcher (1081) can bypass the skill detection step on the multi-skill NLU models (1051) and send the input directly to the last used skill (10511) as the interaction was kept open.

The skills (10511) are composed at least by one of a tv service skill (10517), comprising tv service skill (105171) and tv skill specific model (105172); internet service skill (10518), comprising internet app service (105181) and internet skill specific model (105182); home automation service skill (10519), comprising home automation app service (105191) and home automation skill specific model (105192); and 3^{rd} party service skill (10520), comprising app service (105201) and service skill specific model (105202).

Following, the ambient awareness context layer (103), in terms of functionality defines the capabilities of ambient awareness of the PAMS platform (100), with particular focus on aspects related with the location awareness contextual information like where is the 1^{st} and/or 3^{rd} party device (1011, 1012) located (address, GPS Coordinates, room in the home/building, etc.) as well as ambient awareness data such as weather at that location, temperature, if there is a problem with the network, what is on tv, what is the state of other devices in the same room. This ambient awareness contextual data can be used to enrich the user’s experience and make the PAMS platform (100) a more intelligent system. This Ambient Awareness Contextual Information will be used as decisioning support information in combination with the Ambient Context Awareness manager (1031) to determine the best action and even derive more natural interactions from inferences that can be made using Ambient Information, for example if a user asks the PAMS platform (100) to “change channel” it can infer from the room the 1^{st} and/or 3^{rd} party device (1011, 1012) is located which TV it should execute the command on and not need to ask the user to specify which TV.

The Ambient Context Awareness Manager (1031), located in the Ambient Awareness Context Layer (103), is a core part of the intelligence of the PAMS platform (100). By having ambient context awareness regarding to what is happening in the user’s service premises/surroundings/location, and by being able to enrich each user request with that sort of information skills, the Ambient Context Awareness manager (1031) provides stronger decisions on actions to take without having to ask the user for additional information, inferring that needed information from the ambient awareness enrichment process. From each request of the user, the Dispatcher (1081) will reach out to this Ambient Context Awareness Manager (1031) requesting the user updated specific context in that precise moment in order to enrich the request with metadata before sending it to the multi-skill NLU models (1051). This Ambient Context Awareness Manager (1031) follows a dynamic property bag type of data contract so that the number of ambient and surrounding variables can follow a fully dynamic structure that allows the system to grow along with time as new ambient variables and systems become integrated with this manager. A great example is the ability to know the present weather that is outside the user’s premise’s location without the user having to provide that information. This can be enriched automatically by this manager based only on the incoming request. Another example can be related with the network and/or TV service overall quality, providing possible active problems with the service. Any information that can be read from a sensor, or collected from an external system, for example a 1^{st} and/or 3^{rd} party device (1011, 1012), can be integrated into to this Ambient Context Awareness Manager (1031). This Ambient Context Awareness Manager (1031) has also to be performant with regard to the management awareness of the ambient information, using caching and asynchronous pulling as much as possible, and relying on the Subscriber Pattern to subscribe to global events HUB manager (200) and integrate them with notification services in order to receive updated views of ambient awareness relevant variables from external systems. This intelligent way of managing this information is key to being able to provide this service with the low response time needed for the PAMS platform (100) .

The Core Conversational Management Layer (104) is responsible for the management of all conversations. User interactions with the PAMS platform (100) are singular interactions, text/audio/image input (1013), but many times, each of that interactions may be a part of a multi-step conversation to achieve a goal. These iterations need to be managed so that the system can scale up, avoiding being dependent of sticky session type solutions. Information such as the state of the last response sent, Text/Audio/Image Output (1014), if the conversation ended successfully or if there was something pending. In the case of the multi-step conversation, dialog flow recovers the context from previous steps, as well as the current step that the conversation is at, and the timestamp of the last interaction. This conversation context will be used to decide which skill (10511) should be activated in the case of open dialog flows, missing feedback or multi-step dialog flows, or help the skill (10511) with additional context from previous interactions. This layer also must provide features for dialog context expiration to ensure that a pending dialog from yesterday can be tagged to have an expiration time from the skill (10511) itself so that if a user initiates a new interaction after abandoning the dialog for more than the expiration date that interaction is considered as a new interaction and not try to maintain dialogs forever. This will create a better experience, and therefore, should be part of the core features of the PAMS platform (100) architecture and not be dependent of each skill (10511) implementation of this Conversation expiration feature. The Dispatcher (1081) is a core and central component of the PAMS platform (100), being located in the conversational AI agent core (1087) of the core conversational management layer (104). The Conversational AI Agent Core (1087) is a common and central module to the entire core of the PAMS platform (100) and is responsible for all the common logic and intelligence of understanding the context/domain of the device layer (101) to figure out which skill (10511) should handle the equivalent text/audio/image input (1013). It also has some built-in logic to maintain operating states like awaiting, follow-up, response, or missing input entity, that a skill could reply and keep that context to help streamline the input matching process. Therefore, the Dispatcher (1081) is responsible for orchestrating the interaction with each user of the system, ensuring the execution of all the necessary steps until resolving the requested action or building the requested response to the user. The dispatcher (1081) by itself is responsible for the integration of all the loosely coupled components, ensuring its correct integrated functionality and operationality. From text/audio/image input (1013), the Dispatcher (1081), comprised on the conversational AI agent core (1087), is configured to leverage the multi-skill NLU models (1051), also comprised on the conversational AI agent core (1087), to understand for which skill (10511) is this text/audio/image input (1013) intended. If somehow, in a first approach, the Dispatcher (1081) does not know what action to perform in order to handle with said text/audio/image input (1013 and has a zero-logic result to perform that action, the next step to be conducted and accomplished is the routing of the text/audio/image input (1013) to the correct skill (10511). This is done leveraging a model composed of the main utterances from each specific NLU skill (10512), all bundled up together under an intent for each skill (10511). To make this scalable, the Dispatcher (1081) has a series of skills (10511) it manages using usage simple statistics, grouping together the most used skills (10511), making the model in average more performant and more cost effective. This requirement to include a multi-model dispatcher (1081) is to ensure a more robust and scalable model to any number of skills (10511) in the future. This modular architecture allows the framework of the PAMS platform (100) to be extensible with regard to the number of domains that it can handle, providing augmented versatility and extensibility to system. Once the PAMS platform (100) follows this loosely coupled architecture, there is no need to have a hard dependence of each part of the workflow, but instead the need to present a central core part that ensures the flow and integration of all of these components, which is accomplished and ensured by the Dispatcher (1081). The dispatcher (1081) is also responsible for handling the flow errors that may occur during the execution or implementation of independent skills (10511) comprised on the multi-skill layer (105), showing a strong fallback strategy for user Text/Audio/Image inputs (1013) from the device layer (101) that are not understood or expected. Within these actions, it is possible consider a user asking to mute an application in a mid-way multi-step skill (10511) interaction or a user deciding to abort that same multi-step interaction, starting another one by asking for something else that was unexpected from the current skill’s perspective, but that will match an expected input for a different skill (10511). All of these complex flows and conversation interaction behaviours are within the scope of responsibility of the dispatcher (1081), and they constitute a unique core aspect of this approach. In this context, and with this approach, the skills (10511) are more independent, simpler and more standard, making this solution easier to scale in a complex environment.

The multi-skill NLU models (1051) is a subset of the dispatcher (1081) core logic and it is also located in the conversational AI agent core (1087) of the core conversational management layer (104). The multi-skill NLU models (1051) is comprised of multiple NLU models, the specific NLU skills (10512), that are built automatically based on the available Skills (10511) definitions. This part of the PAMS platform (100), and considering FIG. 3 as support for interpretation, is responsible for deciding, based on the user’s input, what skill (10511) should be used to address the user’s request input (1013). It may skip this part on the cases where context was left open on a given skill (10511) and forward directly the text/audio/image input (1013) to the most appropriate skill (10511). This is one of the key innovative optimizations that the multi-skill NLU models (1051) performs in the PAMS platform (100). Nevertheless, if for some reason the direct skill (10511) isn’t able to process the user’s text/audio/image input (1013), then the dispatcher (1081) will fall back to the Multi Skill NLU Models (1051) to find out if there is another best fitting skill (10511) to redirect the text/audio/image input (1013) to. Another innovative key aspect is the multi-skill NLU model (1051) architecture build directly from each skill’s (10511) training utterances definitions. This single component of innovation in the architecture, allows PAMS platform (100) to be extendible to any number of skills (10511) in the future (avoiding hard limits from NLU maximum intent numbers), allowing manual calibration and model performance by sifting skills (10511) intent definitions from one model to another with lesser conflicts and with a stronger overall model confidence. The feature that it is based on the original utterances from the skill (10511) itself, makes it possible for 3^{rd} parties to submit their “skill package” (10520) to the system and not have the need to grant access to any core piece of the PAMS platform (100) or have developer/operations team integrations as part of the publish process, making it as automatically as possible. Another important aspect in the PAMS platform (100) is the reason why this component, multi-skill NLU models (1051), is detached from the core Dispatcher (1081). This is mainly due to another strong innovation in the architecture that allows PAMS to be agnostic of the underlying NLU Model Technology, and even to be able to work with multiple models using different NLU Technologies at the same time, coexisting in the same solution seamlessly. This is achieved resorting to an abstraction data model and service that this piece of the architecture implements, creating a common language that the Dispatcher (1081) uses and understands about the best matching intent. This way, the settings and integrations are done via a Provider Connect Pattern for each of the supported technologies, with the possibility of adding new connectors in the future and changing connectors without any breaking changes to the remainder of the architecture.

Another important detail of this layer is its responsibility for being device/user aware and the ability to decompose all of that richness from the input itself to make the decision of which skill (10511) to leverage directly from that information if possible. It leverages things like user specific configurations that enable or disable specific NLU skill (10512), or input device awareness that by definition use certain default skills or have other skills that are disabled on that input source/device. And finally, it has the fall back logic implemented in the case of a skill (10511) failing to identify the action intended from the text/audio/image input (1013), this layer will have all the logic of falling back to a default skill (10511), removing context awareness, for example multi-level conversations that may be active and discarding that to try and see if the user aborted its intent of doing that complex action, or in the case of total failure reporting the correct failure to the device/channel (1016).

The specific NLU skill (10512) are in essence extensibility modules that can be added to the core part of this architecture to add domain specific skills to the platform. These skills handle the domain specific interpretation and actions that need to happen to handle the text/audio/image input (1013) from the user and achieve the goal of that input.

The dispatcher (1081) will enrich the text/audio/image input (1013) with the context available and transfer all the knowledge to the skill (10511) that will then use its own means to achieve the goal. Some examples of context could be considered comprise for example the interaction state, if the pending state was passed down by the skill to save in context, ambient context like location detected, device group, etc... these context details are subscribed and defined by the skill (10511) when registered in the platform and are passed down in the JSON message.

These skills (10511) leverage the specific NLU skill (10512) to extract bot the intent itself from the text/audio/image input (1013), as well as all the relevant entities from the input from the JSON response from the NLU model’s API Contract. This implementation is provider independent for the NLU API, so it translates the JSON from any of the supported NLU APIs to an internal Entity Model common to these responses. These skills follow a simple API and leverage the SDK from the core platform that enable the extensibility of this part of the core.

By doing this, they become part of the available skills (10511), and when they get published to the platform the Dispatcher (1081) becomes aware of these skills (10511) and their specific NLU skill (10512), using these utterances as means to understand how to dispatch text/audio/image input (1013) to these skills (10511).

Finally, each skill (10511) may have dependent APIs that perform actions or provide skill specific data or context that are external to the core platform, this is possible and this integration with these external platforms or systems is the responsibility of the skill itself and is transparent to the entire platform.

With regard to the functionality of Multi-Skill Layer (105), it is responsible for the extensibility of the PAMS platform (100), enabling semi-independent skills (10511) to be added at any time to the solution, and with it, extending the potential of the PAMS platform (100) to address any domain that we deem appropriate. This multi-skill Layer (105) will be responsible for enabling and disabling skills (10511) for each user, as well as maintaining which skills (10511) are incompatible and cannot be enabled at the same time. This incompatibility will be determined on the Event Dispatch Layer (108) through the analysis of each skill (10511) utterances and determining a similarity ratio between skills (10511). Another important feature on the mentioned Event Dispatch Layer (108) is the ability to understand what skill (10511) should handle the text/audio/image input (1013) provided by the user. This is done leveraging a multi-instance Natural-Language Understanding (NLU) Model, accomplished by a multi-skill NLU models (1051), which will gather utterances from the specific NLU Skills (10512) and use them to train an intent for each skill (10511), scaling it using multiple NLU models not to limit it to any number of skills. Functionally it will manage the user interaction to enable and disable skills (10511) so the model will only consider enabled skills (10511), nevertheless if a possible but not enabled skill (10511) is matched, this fact should be marked and passed down to the core of PAMS to follow a default dialog to prompt the user if he wants to enable the matching skill (10511).

The Skills (10511) are the action arm of the PAMS platform (100) once they mark-up the edge of the text/audio/image input (1013) flow, as they execute the action that was asked and return with an Text/Audio/Image Output (1014) response to the user. The PAMS platform (100) allows to scale up any number of skills (10511), being the user capable of having different skills (10511) enabled and/or disabled. Also 3^{rd} party skill (10520) providers can use the Skills SDK to develop new skills and submit them to be part of the skills system (10511). The development of a loosely coupled extensible architecture for these skills (10511) is a turnkey advantage in terms of ensuring that the system can evolve and adapt for future needs, as well as it is a key point in terms of innovation and overall architecture. Each skill (10511) needs to ensure the ability to autonomously detect user actions inside their domain. To achieve this, they must define the basis for the Neuro-linguistic programming (NLP) model that will run on each text/audio/image input (1013) request to extract entities and intent of that skill. This is done by submitting a standard form of utterances that PAMS platform (100) will use to create a dedicated NLU Model for that skill (10511), as well as use it to train the multi-skill NLU models (1051) previously mentioned. With the SDK, the skill’s (10511) development can be integrated and injected into the System to be invoked by the dispatcher (1081) as the matching text/audio/image input (1013) arrive. From a high-level overview, the dispatcher (1081) simplified information flow can be mostly described by two main steps as illustrated in FIG. 3. The first one is to find which skill (10511) should be used to process the user text/audio/image input (1013) request based on the multi-skill NLU Model (1051), after which, the specific NLU skill (10512) is invoked. The specific NLU skill (10512) processes the same text/audio/image input (1013) with his domain specific NLU model and then executes the user’s intended action.

FIG. 4 illustrates a possible embodiment where an overview of the User text/audio/image input (1013) Flow through the use of text/voice/image is represented. There are two main steps in the flow diagram. The first one is handled by the dispatcher (1081) up to the point of detecting what skill (10511) should be used while gathering as much additional information as possible to feed the skill (10511). These first steps are where the ASR/TTS model (1092) is performed if the text/audio/image input (1013) is text or Cognitive processing of image, extracting more metadata about the text/audio/image input (1013) itself, and were all the ambient context retrieval (1084) and conversation context retrieval (1083) information is gathered. After the Dispatcher (1081) has finished enriching the text/audio/image input (1013) and has detected what skill (10511) should handle this request, then it hands it over to the specific NLU skill (10512). Here it begins the second main step of the process flow. Specific NLU skill (10512) and intent and entity extraction (10514) are determined, and actions are taken based on the extracted information. Afterwards, the response is generated (10515), and before returning the conversation context built and updated, the overall state is maintained (10516) for future user interactions.

The Cognitive Enhancement Layer (106) enables the PAMS platform (100) to enhance the text/audio/image input (1013) with cognitive AI processing, i.e., Artificial Intelligence processing, namely for text inputs, enable Emotion Analysis, Entity Matching (like landmarks, celebrity names, etc..), Keywork Extraction, Auto-correct suggestions, language detection. For Images input, it will enable Facial detection and identification, object detection, image classification, OCR. These functionalities will enable the core and each skill (10511) to have additional information automatically extracted from the text/audio/image input (1013) and enhance the structured information they get to make decisions on what to do, understand the user’s input, and even enable new and innovative use cases of interaction with the user. This Cognitive Enhancement Layer (106) structures the enhanced information in a standard way so that each skill can navigate and use the extracted information.

The Cognitive AI Services Toolkit (1061) is an abstraction piece for all Cognitive AI Services. From an architectural perspective, this can be seen as a Software Development Kit (SDK) for skills and core pieces of the PAMS platform (100) to use Cognitive intelligence services without the need to integrate a given provider and use this as a toolkit on their workflows. This is implemented in the form of an API that is extensible and serves as the integration layer for these AI Service Providers. This ensures the Loosely coupled architecture principles as well as makes it possible for 3^{rd} party skills implementations to leverage these services without hardcoding dependencies to API versions of these providers, making the system more robust and provider agnostic.

To centralize common AI assets, the PAMS platform (100) makes available, as part of its API/SDK for both skills (10511) and the Dispatcher (1081) itself, a common set of generic AI models as a service that can be used by any skill or other module in the architecture to process data and extract information or support in the task and decision that must be done in each of these processes.

This Common Bot Intelligent Services module (1062), through the use of entity linking service (10621), face recognition (10622), computer vision service (10624) and emotion recognition service (10625), exposes AI services to process Images such as Face Detections, Face Identification, Face Biometric Information Extraction, emotion recognition, or other computer vision services such as Object Detection, OCR, image description. Other AI services available to process text like Entity Linking, Text Analytics, Translation Service, or Auto Correct Services.

By making this common bot intelligence services (1062) AI module globally generic, and a part of the available API for each skill (10511), it is possible to achieve a more agile and stronger extensibility of each skill (10511), enabling also an easier extensibility of the PAMS platform (100) by extending the available AI services that compose this module.

The Knowledge Layer (107) is responsible for maintaining all the knowledge for the PAMS platform (100), structured, relational, or Unstructured. It stores all the knowledge about products, entities, actions and makes this information available through a standard Application Programming Interface (API) to all its skills. In a way, this layer represents the memory and information database provides the PAMS platform with intelligence, contextual information transient of persistent is deposited here, as well as all other fixed information.

The Event dispatch layer (108) is responsible for all the events that get triggered in PAMS platform (100), both scheduled by a user, or from an ambient awareness probs that the user can register to listen to. Each event will get triggered and this layer maintains which users subscribed the event and triggers the corresponding skills (10511) with both the event’s contextual data and type, as well as the user’s contextual data so that the skill (10511) can proceed to handle the triggered event. Event dispatch layer (108), as illustrated in FIG. 5, is comprise by an AI Agent Scheduled Tasks (302) and AI Live Events (303), wherein the AI Agent Scheduled Tasks (302) further comprises a scheduler (3021) and an event dispatcher (3022), and wherein the AI Live Events (303) comprises an event hub (3031), a notification service (3032) and a event logic (3033). Scheduled events are the simplest from a functional perspective, as they can be created by a skill (10511) to trigger at a set time or as a countdown timer, both these cases are part of the feature set this layer enables. Registration of these scheduled event is done through an API call, and in the registration, the skill (10511) can pass down an Object Status that will be returned when the scheduled event triggers. The possibility to disable/cancel a scheduled event should also be part of the feature set enabled by this layer. Ambient events are also part of this layer’s features and skills, and resort to the use of an API to register listeners to these events, the list of possible ambient events is an open process, and it is always a growing list, and the API contract is scalable so that skills won’t need to change the API contract itself when new events become available. Ambient events can be anything from weather changing events, to TV shows starting and ending events, soccer team scored a goal events, new device detected in my home Wi-Fi events, etc. These events enable skills (10511) to actively engage users about certain things that may be presently happening, enable users to create complex actions based on matching events to actions. The AI Agent Scheduled Tasks (302) & Live Events (303) comprised in the event dispatch layer (108) gives the PAMS platform (100) the ability to have both awareness of elapsed time via a scheduler to enable scenarios like a user asking this platform to send him a reminder on a given time and date. It is also responsible for triggering events and registering events in context with user requests, likes or needs that happened somewhere else in the ecosystem, something similar to ambient awareness but for the entire platform ecosystem and reach. For example, a new episode of a movie a given user likes was added to the catalogue, a new device was added to a user’s network and needs approval, etc. By having a generic and common way of skills to be able to register specific events and have those events to be delivered context aware, makes all the triggering and reaction type use cases easy to develop and more powerful through the centralization of these abilities in this common context aware layer.

The Data Seeding Layer (109) is responsible for the track-back of all the data sources/seeders that contain the data for the Knowledge Layer (107) and update that information. These AI data seeders (1091), further comprised by a user profile and actions seeder (10911) and a catalogue data seeder (10912), are both responsible for gathering the information as well as performing the necessary transformation to materialize the data into the Data Model defined in the knowledge layer (107). This Data Seeding Layer (109) must be extensible as new data needs are identified for the PAMS platform (100) and will require new AI data seeders (1091) to be implemented and more data to be transformed and imported. This layer should be considered extensible in such a way that new AI data seeders (1091) are added at any time and run independently if needed from the remaining seeders.

This module is responsible for all of the modules that collect information from external data sources and rematerializes that information into the core of the context DBs in the cross-cutting core context and knowledge bases (301). In this way, all these tasks can have their own lifecycle, independent from the rest of the platform and grow organically as new sources become available or additional needs for data import arise.

The Health Monitoring and Reporting Layer (110) is responsible for all auditing and logging operations for PAMS platform (100). All the layers from the PAMS platform (100) send audit events and logs to this layer, and all this unstructured data is stored and processed to produce multiple performance, business and Health monitoring reports. Another important feature of this layer is the AI predictive analytics and anomaly detection which is monitoring the platform for errors and faults to make sure that the platform’s health is always at his peak. It is still responsible for monitoring every piece of this Cross Cutting Core Services (1101) module through application monitoring (11011), application logs (11012) and reporting dashboards (11013) analysis from the dispatcher (1081) to each skill (10511), monitoring usage, performance and errors, keeping track of the platforms health while collecting usage and business KPI metrics and diagnostic data such as Application and Error Logs. All of this data flows to a common global data repository and this enables many reporting dashboards to be built and for both operation and business monitoring.

Additionally, as an optional part of the overall text/audio/image input/output (1013, 1014) processing flow of the PAMS platform (100) architecture, it is used Automatic Speech Recognition (ASR) / Text to Speech (TTS) Models (1092). The inputs provided to this ASR/TTS model (1092) are only used if the 1^{st} and/or 3^{rd} party devices (1011, 1012) requests for Audio Output (1014) or sends Audio Input (1013) to the system. This is a simple and very plain part of the architecture. It mainly serves as an abstraction layer for the ASR/TTS services themselves ensuring the loosely coupled architecture core principles for the solution. By having this Module of the PAMS platform (100) detached from the core, the solution is not locked into any of the providers of these models, allowing their replacement at any given time.

The Cross Cutting Core Context and Knowledge Bases (301), responsible for the Contextual awareness pieces of the PAMS platform (100), maintains and persists contextual information relevant for each of the skills (10511), materialized in a Data Model ready for consumption and optimized for skill (10511) integration and overall performance. This platform needs to be performant with regard to the response times. These need to be really small due to the nature of the types of interactions that it handles and that it can enable with the users. Therefore, all of the architecture of the PAMS platform (100) is built for high performance, extensibility, and to be common to all of the platform needs. In terms of capabilities, it needs handle both structured and unstructured data, as well as persistent and transient information.

To maintain the predetermined performance and overall requirements, this Cross Cutting Core Context and Knowledge Bases (301) resorts to the use and leverage of high performant repositories such as cache DB services (3011) to allow current skill (10511) contexts to be maintained. An suitable example can considered as an action like multi-level dialog command where the user provides through partial text/audio/image input (1013) that can be transiently stored as contextual data during each step of the interaction.

Unstructured table storage (3015) is used for user persistent contextual information, where user likes or dislikes are considered. Entity data and their relationships are stored in a Graph DB (3013) which include catalogue entities and their metadata for different products in a Media Catalog for example.

Knowledge base information (3014) is used for different contexts and topics. Context related with, for example, pairs of questions and answers about a topic like football club or a city, or even support questions on how to solve a problem with an app or service. Finally, a secure vault (3012) is used to keep secret information that may be handed over in the interaction, for example user network passwords and other sensitive information.

1. A computer-implemented system (100) for handling input data provided by users via natural input interfaces, comprising
a set of layers arranged in a modular and loosely coupled architecture,
wherein the set of layers are adapted to interpret and manage several types of contextual information from the user input data, while permanently improving decisioning and response times, enabling increasingly complex interactions with the user.

2. The computer-implemented system (100) according to claim 1, wherein the set of layers comprises at least one of a
Device Layer (101),
Conversational Context Layer (102),
Ambient Awareness Context Layer (103),
Core Conversational Management Layer (104),
Multi-Skill Layer (105),
Cognitive Enhancement Layer (106),
Knowledge Layer (107),
Event dispatch layer (108),
Data Seeding Layer (109), and
Health Monitoring and Reporting Layer (110).

3. The computer-implemented system (100) according to claim 1, wherein the several types of contextual information comprises at least one of a
Persistent User Specific Contextual Information composed by user preferences such as settings and configurations added to improve decisioning;
Persistent Secure Information composed by keywords, passwords or authorization tokens securely stored to minimize security measures for internally access said info; and
Conversational Transient Information composed by multiple independent hosts configured to maintain a set input data iteration alive with the user.

4. The computer-implemented system (100) according to claim 1, wherein the Core Conversational Management Layer (104) is composed by a conversational AI agent core (1087) comprising a dispatcher (1081) and multi-skill NLU models (1051), the conversational AI agent core (1087) being configured to
perform and understand multi-step conversational context of the user input data through the device layer (101) in order to determine which output data should handle said user input data, and
identify a conversation failure fallback from a user input data through a dedicated mechanism configured to allow a transient context to be considered, allowing to start a new command request.

5. The computer-implemented system (100) according to claim 1, wherein the multi-skill NLU models (1051) comprises multiple NLU models.

6. The computer-implemented system (100) according to claim 1, wherein the multi-skill layer (105) is composed by skills (10511) which comprise specific NLU skills (10512) and specific skill actuators (10513), the multi-skill layer (105) being configured to enable, disable and include additional skills (10511) to ensure adaptability.

7. The computer-implemented system (100) according to claim 1, wherein the Cognitive Enhancement Layer (106) is configured to enrich the user input data with cognitive AI processing through the reuse of the input data thus creating enriched standards for all used skills (10511).

8. The computer-implemented system (100) according to claim 1, wherein the knowledge layer (107) is configured to maintain all the input data, output data and knowledge created by the set of layers structured, relational, and/or unstructured.

9. The computer-implemented system (100) according to claim 1, wherein the ambient awareness context layer (103) is configured to update a materialized view of the surrounding world, through an Ambient Context Awareness Manager (1031), comprising at least two variables:
surrounding environment, and
interaction channel location
wherein the combination of the at least two variables allow to improve the dispatcher (1081) decision and response time by providing to the skills (10511) additional data and metadata that value and enrich the data input in order to obtain more accurate and engaging interactions with the user.

10. The computer-implemented system (100) according to claim 1, wherein the natural input interfaces are comprised in a Device layer (101) are composed by 3rd party voice/text/image interactive systems (1011) and/or 1st party voice/text/image interactive systems (1012) connected to a Single Cross Platform Endpoint (1019) through channels (1016), said device layer (101) being configured to both capture video, images, audio or text input (1013) and/or output visuals such as video, images, audio or text.

11. The computer-implemented system (100) according to claim 1, wherein the event dispatch layer (108) comprises an AI Agent Scheduled Tasks (302) and AI Live Events (303) configured to deliver external events to the dispatcher (1081) triggered by an external Global Events Hub Manager (200) through an Event Context and Data (10814).

12. The computer-implemented system (100) according to claim 1, wherein the data seeding layer (109) comprises a set of independent AI data seeders (1091) configured to track-back, gather, perform the necessary modifications, and deliver the input data, output data and knowledge created by the set of layers to the Knowledge Layer (107).

13. The computer-implemented system (100) according to claim 1, wherein the Health Monitoring and Reporting Layer (110) is configured to collet, process and store audit and log events from the remaining layers to produce multiple performance, business and Health monitoring reports which comprise predictive analytics and anomaly detection.

14. The computer-implemented system (100) according to claim 1, wherein the conversational context layer (102) comprises a conversational context manager (1021) configured to maintain multi-step conversations with the users, ensuring maintenance of conversational statements and preferences particular to said conversations through storing and collecting conversational context for each user input data.

15. The computer-implemented system (100) according to claim 1, wherein the dispatcher (1081) is configured to retrieve Output data in response to a user input data through the natural input interfaces while providing related details with the Conversational Context Manager (1021) for storage, determining what skill (10511) or Multi Skill NLU Models (1051) is suitable to be addressed to the current conversational context alongside with the remaining metadata.

16. The data processing system, comprising the physical means necessary for the execution of the computer-implemented system described in claim 1.

17. The computer program, comprising programming code or instructions suitable for carrying out the computer-implemented system described in any of the previous claims, in which said computer program is stored, and is executed in a said data processing system, remote or in-site, for example a server, performing the actions described in claim 1.

18. The computer readable physical data storage device, in which the programming code or instructions of the computer program described in claim 16 are stored.
